(19) United States
(12) Patent Application Publication
(10) Pub. No.: US 2007/0015537 A1
(43) Pub. Date: Jan. 18, 2007

(54) Wireless Hands-Free Audio Kit for Vehicle

(75) Inventors: Jack DeBiasio, Moorpark, CA (US); Kasidy Alves, Oxnard, CA (US)

Correspondence Address: McDERMOTT WILL & EMERY LLP;34th Floor, 2049 Century Park East, Los Angeles, CA, 90067, US

(73) Assignee: Scosche Industries, Inc.

(21) Appl. No.: 11/457,314

(22) Filed: Jul. 13, 2006

Related U.S. Application Data
(60) Provisional application No. 60/699,100, filed on Jul. 14, 2005.
(60) Provisional application No. 60/803,808, filed on Jun. 2, 2006.

(51) Int. Cl. H04M 1/00

(52) U.S. Cl. 455/556.1

(57) ABSTRACT

A portable plug device for use in a vehicle is disclosed for enabling wireless transmissions from an audio source, such as an mp3 player or the like, to a head unit of a car stereo for reproduction of the audio content over speakers in the vehicle. The portable plug device includes a cord suitable for being attached to the auxiliary unit of the stereo head unit, or another location integrated in the vehicle which controls audio functions. In one configuration, the portable plug further includes a wireless transceiver for sending and receiving data and control signals to and from an audio source connected to a second wireless transceiver. The portable plug device can be used to receive control signals from the stereo equipment integrated in the vehicle so that an occupant can control features such as volume, skip track, pause and stop by using the audio controls integrated in the vehicle. In another configuration, the portable plug device includes a microphone to enable the occupant to have a telephone conversation hands free using a telephone compatible with the wireless standard implemented in the portable plug device. In still other implementations, an occupant can use the portable plug device to receive audio content, and if he or she receives an incoming call, the speakers are muted and the call is taken. After the call is taken, the occupant can resume listening to audio content from the audio source over the vehicle speakers.

### RELATED APPLICATION DATA

This application claims priority to provisional application Ser. No. 60/699,100 filed Aug. 15, 2005, entitled “Portable Audio Device With A Wireless Connection To A Car Stereo”, and provisional application Ser. No. 60/803,808 filed Jun. 2, 2006, entitled “Wireless Do-It-Yourself Hands-Free Audio Kit For Vehicle Background.” The content of these provisional applications are incorporated by reference as though fully set forth herein.

### BACKGROUND

1. Field

The present invention relates to wireless devices for use with vehicles, and more particularly to a wireless audio device used to transmit audio from portable devices over vehicle speakers.

2. Background

An increasingly popular entertainment feature for consumers is the use of portable devices in vehicles to transmit audio over speakers in the vehicles. One example includes the use of a cellular telephone that has the capability to transmit voice over the speakers in the vehicle and to receive voice using a hands-free microphone. Another example is a music player using MPEG1 layer 3 (MP3) audio compression to reproduce music in stereo over the vehicle's speakers.

For either application, consumers desire a solution that produces high quality sound and uses a minimum amount of extraneous equipment to minimize costs, maximize sound quality, and minimize the negative aesthetic effects associated with cumbersome wiring in the vehicle's interior.

Various “after-market” devices designed to play music sourced from a portable audio player have been implemented or proposed in the literature. All of these approaches rely on the transmission of radio waves to the vehicle's antenna for playback of the audio contained on the portable device over the vehicle's radio. In one approach, as shown in U.S. Patent Application Publication No. US 2005/0049009 A1 filed by Yamamoto, a portable audio player is connected to a “plug” device that fits into a standard cigarette lighter of a vehicle for supplying power to the plug transmitter. The plug device processes the signal from the portable audio player and retransmits it using a wireless transmitter as an AM or FM radio wave in the frequency spectrum of the vehicle's radio. The radio wave is received by the vehicle's standard radio antenna, and the music from the portable audio player is played using the vehicle's radio through its speakers.

In another approach, as disclosed in U.S. Patent Publication No. US 2003/0053378 A1 filed by Lovin et al., a portable device (such as a cell phone or personal audio player) containing a wireless transceiver transmits (or receives) signals to or from a second wireless transceiver contained in a cylindrical apparatus. The cylindrical apparatus processes the received signal and retransmits it over the FM radio spectrum. The cylindrical apparatus is connected directly to the vehicle's radio by a coaxial cable and provides audio through the radio over a designated FM frequency.

Similar approaches using a cigarette lighter plug as a combined transmitter and power source, such as in U.S. Patent Publication No. US 2005/0123147 A1 filed by Everett et al. and U.S. Patent Publication 2005/0143880 filed by Schedevy, likewise use an FM transmitter to stream audio content from the portable device to the vehicle's radio. Schedevy also discloses the use of a Digital Audio Broadcast (DAB) transmitter to transmitter audio to a DAB antenna resident on the vehicle.

These approaches have significant drawbacks. Most notably, the quality of the audio is significantly less than the near-CD quality of most modern portable audio players, including those that use digital compression techniques such as mp3, .wma, etc. Both the FM and AM frequency bands lack the dynamic range to reproduce the higher quality sound associated devices that use these digital compression schemes. Further, traditional AM and FM frequency bands are susceptible to significant interference, both from physical obstacles that interfere with the transmission of radio waves and from other FM and AM sources transmitting at or near the same frequencies. In short, sound quality is significantly compromised using the FM/AM radio bands associated with these prior approaches.

Additionally, the use of a DAB transmission scheme, while allowing for a higher dynamic range, is likewise susceptible to significant interference from neighboring DAB transmissions and other obstacles, and has traditionally provided sound quality neighboring that provided by using the FM spectrum. Further, the use of a DAB transmitter has the additional drawback in that the vehicle must have integrated or retrofitted DAB reception and demodulation capabilities, which is unavailable in the majority of vehicles on the road today.

Other useful features for a device enabling a connection to compact communication devices include various command and control capabilities. The majority of vehicles today are not equipped with the integrated technology to enable a cellular telephone to send voice over the vehicle stereos. For such vehicles, a driver is limited to using the cellular telephone in the traditional “non-hands-free” fashion, dedicating one hand to steering the automobile and the other to making or receiving a cellular telephone call. When one is using a portable audio player, for example, the vehicle occupant must typically fumble with the buttons of the small compact player in order to skip tracks or adjust the volume, which may distract the driver.

Still another desirable feature in the art is to have a portable device capable of using both an audio source and a cellular telephone that has the ability to switch between applications. Existing devices rely solely on the use of a mobile telephone with wireless capability pre-integrated into the vehicle for handling mobile telephone calls using the vehicle's speakers and a corresponding microphone. For enabling the transition between the use of a mobile telephone and a discrete PDA or MP3 player, etc., a separate device must be employed in the interior of the automobile. These approaches do not combine the ability of the automobile to reproduce audio from the MP3 player, and then to switch over to a second mode as necessary to make outcoming or incoming “hands-free” cellular calls.

### SUMMARY

Accordingly, one object of the present invention is to provide a portable apparatus that enables a portable audio player to stream CD-quality music to the speakers in a vehicle.

Another object of the present invention is to provide a portable apparatus that enables a user to make cellular telephone calls using the vehicle speakers and a hands-free microphone in vehicles not equipped at the factory with technology to enable the same.

Another object of the present invention is to enable the cellular telephone, PDA, MP3 player, or other audio-based device to interface with other devices on a vehicle bus.

Another object of the present invention is to provide a portable apparatus that has “command and control” capabilities to enable the audio equipment pre-integrated in the vehicle to send and receive control signals to and from a portable audio source control signals to the vehicle's radio to enable a user to employ functional buttons on the radio, steering wheel, or dashboard to send back control data via the portable apparatus to the portable audio device, such as stop, play, skip, etc., or to send back control signals to the telephone, for example, when the user answers the phone using the portable apparatus.

Another object of the present invention is to provide a portable apparatus that has the capability to “switch” between one mode whereby a user can playback audio from a portable device over the vehicle speakers, and a second mode whereby a user can make or receive a cellular telephone call while disabling the playback in the first mode.

These and other objects and advantages of the present invention will become readily apparent in the foregoing disclosure.

In one aspect of the present invention, an apparatus for reproducing audio in a vehicle includes a portable device configured to fit into a cigarette lighter including a wireless receiver and one or more conductors coupled to an output of the wireless receiver, a portion of the one or more conductors extending as a cord from the portable device, the cord configured to connect to an auxiliary input on a stereo head unit, the portable device further including at least one button disposed substantially on its perimeter for controlling the receipt of audio content, wherein the wireless receiver is configured to receive audio content using a Bluetooth protocol from a portable wireless transmitter coupled to a portable audio device, wherein the audio content is transmitted to the auxiliary input over the one or more conductors, and wherein the stereo head unit reproduces the audio content over speakers in the vehicle.

In another aspect of the invention, a portable device is disclosed for sending and receiving wireless communications in a vehicle and configured to fit into a cigarette lighter, the portable device including a first wireless transceiver for sending and receiving data, and a cord extending from the portable device and configured to connect the first wireless transceiver to one or more conductors in the vehicle which are dedicated to controlling audio functions, and a microphone disposed on the portable device and coupled to an input of the first wireless transceiver, wherein the portable device is configured to transmit and receive control signals from one of a second wireless transceiver and a mobile telephone, the second wireless transceiver coupled to a portable audio source for enabling communications with the first wireless transceiver; and wherein at least one button disposed on a perimeter of the portable device is configured to control transmission of audio content for reproducing the audio content on speakers in the vehicle.

In another aspect of the invention, an apparatus for reproducing audio in a vehicle includes a portable device configured to fit into a vehicle cigarette lighter including a wireless receiver, a first wireless transmitter, a microphone, at least one button disposed on its perimeter, a controller coupled to the wireless receiver, and a cord extending from the portable device and configured to fit into an auxiliary input jack of a stereo head unit, wherein the wireless receiver is configured to receive audio content during a first interval from a second wireless transmitter coupled to a portable audio player and from a cellular telephone during a second interval, wherein the wireless transmitter is coupled to the microphone and configured to transmit audio content to the cellular telephone during the second interval, and wherein the controller is configured to allocate a wireless communication channel only to the portable audio player during the first interval and only to the cellular telephone during the second interval for enabling reproduction of audio content over speakers in the vehicle, and for enabling transmissions of audio content from the wireless transmitter to the cellular telephone during the second interval.

In another aspect of the invention, a portable device configured to fit into a cigarette lighter socket of a vehicle includes a receiver using a Bluetooth protocol, memory and a central processing unit for controlling the receiver, a cord extending from the portable device with an output jack at its terminating point configured to connect to an input jack in the vehicle associated with control of a stereo head unit and to transmit signals from the receiver to the head unit, and at least one button disposed on its perimeter, wherein the portable device is configured to receive wireless signals from a transmitter module for transmitting audio content from an audio source coupled to the transmitter module to the receiver in the portable device, and wherein the portable device is configured to transfer the audio content via the cord to the head unit for playback of the audio content over the speakers.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive

### BRIEF DESCRIPTION OF DRAWINGS

FIG. 1 is an illustration of the portable plug device in accordance with an embodiment of the present invention.

FIG. 2 is an illustration of a portable audio source and a transceiver module used in connection with an embodiment of the present invention.

FIG. 3 is an illustration of the portable plug device transmitting and receiving signals from a mobile telephone, in accordance with an embodiment of the present invention.

FIGS. 4A and 4B are conceptual flow diagrams illustrating the steps a user may take in implementing the features of an embodiment of the present invention.

FIG. 5 is an illustration of a vehicle interior with a stereo head unit, portable plug device, portable audio player, transmitter, and mobile telephone in accordance with an embodiment of the present invention.

FIG. 6 is an illustration of a vehicle dashboard, portable plug device, portable audio source, and transceiver module in accordance with an embodiment of the present invention.

FIG. 7 is an illustration of a portable audio source piggybacked onto a transceiver module in accordance with an embodiment of the present invention.

FIG. 8 is a conceptual flow diagram illustrating the steps a user may take in implementing the features of an embodiment of the present invention.

FIG. 9 is a conceptual flow diagram illustrating the steps a user may take in implementing the features of an embodiment of the present invention.

### DETAILED DESCRIPTION

In one embodiment, the present invention includes a portable device containing a plug configured to fit into a standard cigarette lighter socket. The portable device contains a receiver that uses a standard Bluetooth protocol. The Bluetooth protocol in the portable device may be implemented by digital logic circuitry, a dedicated processor coupled to memory containing code for execution by the processor, and a transceiver under control of the processor and digital logic circuitry. The portable device further includes a cord that is electronically coupled to the Bluetooth receiver's output and is configured to fit into the auxiliary input of a stereo head unit. In this embodiment, portable audio player is further coupled to a standard Bluetooth transmitter for wirelessly transmitting audio content in a vehicle to the Bluetooth receiver resident in the portable plug device. The headphone output of the stereo jack is connected to an input of the portable transmitter. The portable transmitter modulates, and in one embodiment, converts the signal into an A2DP (Advanced Audio Distribution Profile) format for wireless transmission of audio content having a high dynamic range and signal to noise ratio. The transmitted audio content is received at the Bluetooth receiver in the portable plug device, reconverted into an appropriate format (e.g., RCA stereo), and transmitted to an auxiliary input of a stereo head unit.

In other embodiments, where the auxiliary input is in the rear of the head unit, an optional harness may be used which extends the cord to the rear of the head unit. A wiring harness with an appropriate adapter may be used as necessary depending on the make and model of the vehicle and/or the stereo head unit.

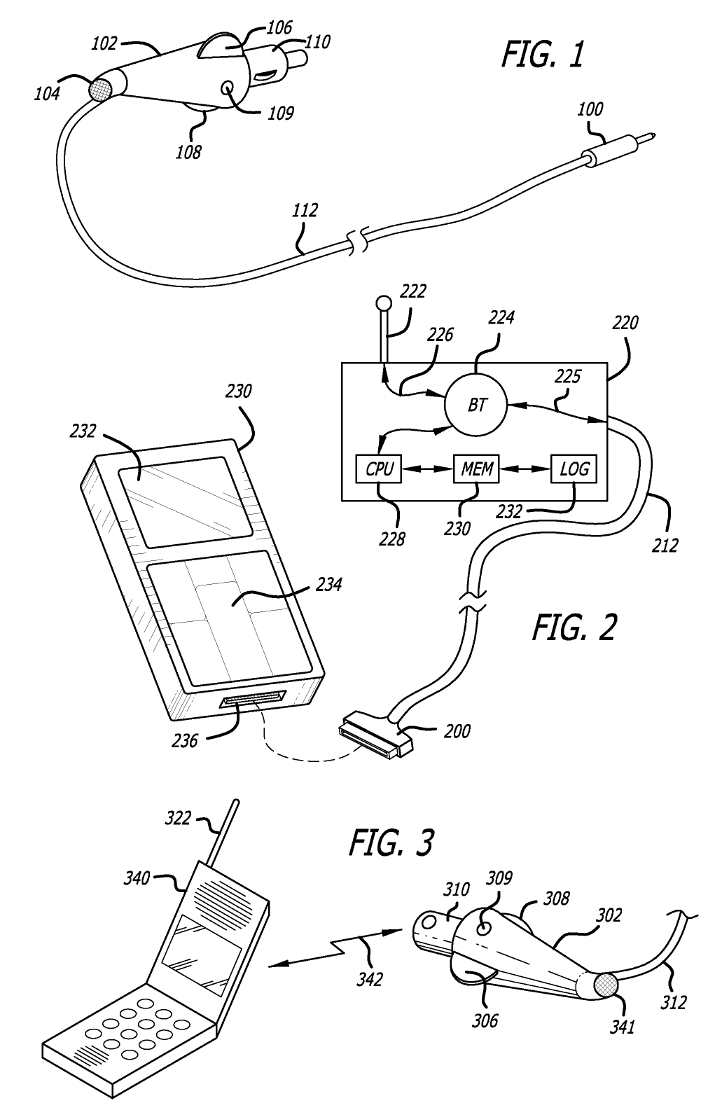

In another embodiment, the present invention includes a portable device resembling a plug that fits into a standard cigarette lighter socket (see FIG. 1). At an area of the portable device opposite the area that fits into the cigarette lighter extends a cord with a plug that fits into an auxiliary input on a head unit of a stereo. The portable device contains within its outer shell a transceiver, such as one designed to transmit and receive signals using the Bluetooth Protocol suite, coupled to logic circuitry, a processor, and a controller. A second portable device is coupled to a second transceiver module. The portable media device, such as an mp3 player, includes a socket, such as a 30-pin socket. The portable audio source is connected to the second transceiver module via a cord that emanates from the second transceiver module and terminates with a connector compatible with the multi-pin socket on the portable audio device. Thus, for example, if the multi-pin socket on the portable audio device is female, the connector terminating the cord from the second transceiver would be male and otherwise be compatible with the multi-pin format, enabling for a coupling of the two devices.

Certain pins of the multiple pins on the portable audio device may contain both data signals for sending to the second transceiver module audio data to be streamed over the air via the Bluetooth protocol to the receiver portion of the Bluetooth transceiver resident in the portable plug device. Certain other pins may supply power to the portable media device. Yet other pins may carry control signals to and from the portable audio device, which are passed via the Bluetooth connection to the portable plug device, and through the radio via, for example, the auxiliary input of the stereo. The control signals may pass through a dedicated control channel, or they may be contained within the signal using a predefined protocol. One function of the control signals in this embodiment is to allow the portable media player to pass control of stereo-associated functions like skip, pause, playback, etc., to the stereo head unit. In this instance, the vehicle occupant will have control over the radio in a manner similar to if the portable media device were integrated into the stereo head unit itself.

In another embodiment, the present invention includes a portable device resembling a plug that fits into a standard cigarette lighter socket. The cigarette lighter socket provides power to the portable device. The portable plug device further includes a wireless transceiver for receiving high quality “short range” wireless communications from an audio source (such as an MP3 or WMA player, PDA, etc.) over a first time interval, and for receiving short range wireless communications from a mobile telephone over a second time interval. The wireless transceiver is connected by a cord emanating from one side of the cigarette lighter plug into an auxiliary jack typically resident on either the head unit of the vehicle's radio system, or in the dashboard console. The specific location of the auxiliary input depends on how the vehicle (such as, for example, the head unit is an aftermarket auxiliary unit or an Original Equipment Manufacturer (OEM) head unit) is constructed and may include the face of the head unit, the rear of the head unit, a dedicated area on the dashboard or console of the head unit, or another location. In still other configurations, the auxiliary input is not used, and the cord emanating from the portable device may be connected to a contact point integrated into the vehicle having one or more conductors that is dedicated to receiving and transmitting audio or media-related signals.

The wireless transceiver can plug into a charger port for OEM head units using a changer/aux input harness or an auxiliary input connector on aftermarket head units. Auxiliary inputs on aftermarket head units may include a simple 3.5 mm plug resident on the face of the unit. Alternatively, as described above, aftermarket head units may be located on the back of a head unit and may include, for example, a standard RCA-line level input. In this latter case, some embodiments may include a mini jack to RCA cable that a user can run from under the dash for the portable plug device to plug into. The mini jack to RCA cable includes a 3.5 mm headphone jack to an RCA cable, which consists of a left and a right stereo channel.

In other instances, a CD changer port input is located on the back of a stereo head unit. In one configuration, a manufacturer specific cable may be run from the portable plug device to the CD changer port. Any device making use of the CD changer ports should be disconnected when these adapters are used; however, in one embodiment a dual adapter may be used to selectively connect a CD changer or the portable plug device to the head unit.

The portable plug device further may include a built-in microphone designed to receive voice during a second interval when the cellular telephone is in use. The microphone, in turn, is coupled to a short range wireless transmitter (part of the transceiver in one embodiment) designed to transmit the audio content containing the voice information in an appropriate format to a mobile telephone within the range of the transmitter.

In some configurations, a separate “dongle” may be either integrated into the portable device or resident proximate to the car stereo, or in another location in the vehicle's interior. The purpose of the dongle is to convert the format of the audio data into the specific protocol used by the auxiliary or other stereo-associated input/output contact point, for reproducing high quality audio content over the vehicle speakers. Similar conversion functionality may be resident in the portable device or wireless transmitter for converting the caller's voice into an electrical signal for communicating the audio using a protocol consistent with the portable audio device or mobile telephone.

The present invention may also include a short range wireless transmitter that is connected to the output of a portable audio player, such as an MP3 player. In one embodiment, the wireless transmitter connects directly to the stereo output jack of the portable audio player.

The standard of wireless transmission that may be used in the present invention can be any suitable type, including one of the several wireless standards available or in development. In a preferred embodiment, the standard includes one that is minimally susceptible to electrical interference over the allowed range, and provides both a high dynamic range and high signal-to-noise ratio to maintain the integrity of the embedded audio signal. Examples include Bluetooth™, HomeRF™, the various IEEE 802.11 Wi-Fi standards, Skinplex™, Ultra-Wideband (UWB), IEEE ZigBee, Ambient Network, etc.

An auxiliary input is an input on the head unit of a receiver that enables one to connect a portable CD, PDA, laptop computer, digital audio player, etc. to enable reproduction of high quality audio over the vehicle's speakers. Certain head units use ⅛″ stereo mini plug inputs, some use 3.5 mm inputs, and some use built-in stereo RCA inputs. Whether the auxiliary or comparable input is found on the face of the head unit, on its rear panel or proximate to the head unit on the side of the dashboard console or head bezel, it will be appreciated that any such input can qualify as the input to the head unit or stereo-associated circuitry for purposes of the invention.

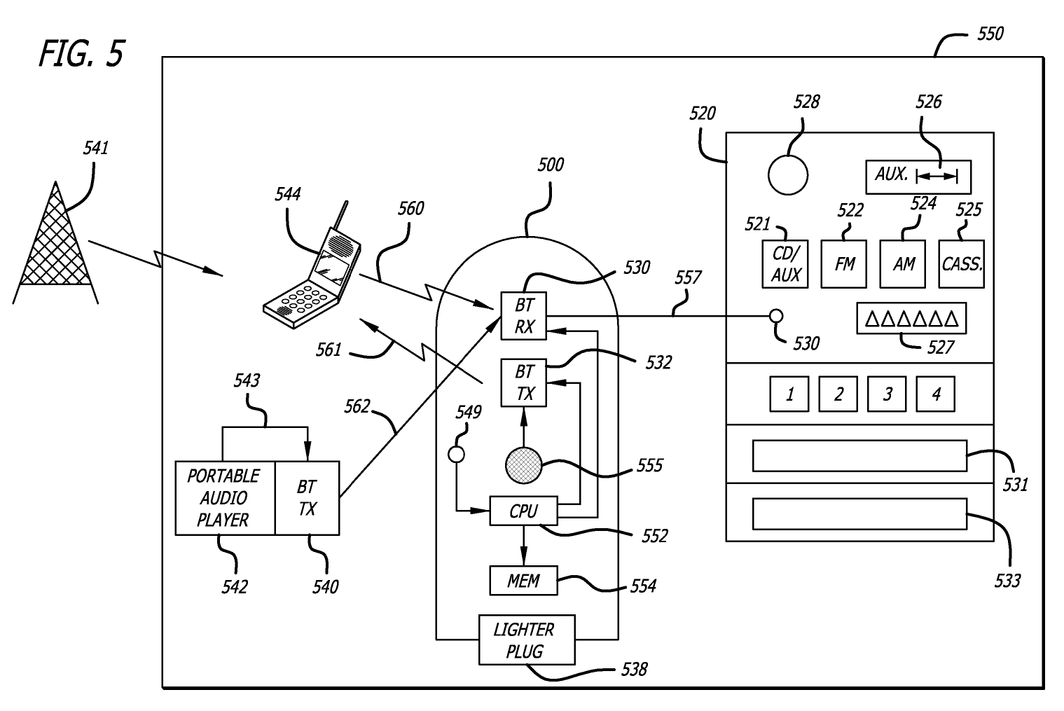

Shown in FIG. 1 is a pictorial representation of the portable plug device in accordance with an embodiment of the present invention. The device includes the portable plug/transceiver unit 102, which further includes microphone 104, rigid plastic extenders 106 and 108 which can also function in some embodiments as push-in buttons, and a standard hardware unit for power 110 which is used for insertion into a standard vehicle lighter. Attached at the other end of the portable unit is cord 112, and terminating at the end of cord 112 is a jack 100, which may in some embodiments be a 3.5 millimeter jack. Button 109 is a “multi-function” button used in some embodiments. As will be seen in connection with FIG. 5, the portable plug device shown in FIG. 1 contains the electronics necessary for implementing the appropriate standard for high quality wireless reception and transmission. In other configurations, portable plug device 102 may include only a wireless receiver (such as a Bluetooth receiver) without a microphone, and with electronic circuits capable of transmitting data from the receiver through cord 112.

FIG. 2 shows an example of a portable transceiver module 220 used with the portable plug device, in accordance with an embodiment of the present invention. Although the shape of the portable transceiver module 220 may vary, the transceiver module 220 may consist of a flat rectangular box, as will be shown in subsequent figures. Transceiver module 220 includes Bluetooth transceiver 224, antenna 222 (which may in some configurations be internal to the device), and a bidirectional conducting wire (or set of conducting wires) 226 for sending wireless data to and receiving wireless data from the Bluetooth transceiver. The Bluetooth transceiver is further coupled (“coupled” means either directly or through intervening circuitry) to a central processing unit 228. Also present in transceiver 228 is a memory circuit 230 for buffering and storing data, as well as for storing code to be executed by CPU 228, and various digital logic circuitry 232 for implementing functions such as encoding/decoding, multiplexing, and other necessary digital logic that may be used by transceiver module 220. For supplying power, the transceiver module 220 may also include a battery (not shown) or alternatively, circuitry which includes a set of conductors to be attached to an appropriate place in the vehicle to obtain power.

From the Bluetooth transceiver 224 runs bidirectional conductors 225 that extend to a perimeter of the device and into cord 212, which contains an insulating layer around the conductors and which terminates in a multi-pin adapter 200.

In one embodiment, the Bluetooth transceiver 224 may consist of a simple Bluetooth transmitter for transmitting data to portable plug device 102 (FIG. 1). In addition, in this embodiment, cord 212 and multi-pin adapter 200 may instead be a cord that has a terminating pin for connecting into a standard headphone jack.

Also shown in FIG. 2 is a portable audio player 230. The portable audio player 230 contains a screen 232 for displaying songs, playlists, power consumption, etc., and control buttons 234 for using the features on portable audio player 230, which may be an mp3 player. Alternatively, the portable audio player 230 may constitute any device that can source audio, including, for example, a mobile telephone, personal digital assistant (PDA), laptop computer, and the like.

The player 230 also contains (not shown) a standard headphone jack so that a user can listen to music using headphones in the conventional manner. Portable audio player 230 also contains a multi-pin input/output fitting 236. The various pins associated with this fitting may include for example, audio data from the portable audio player, input and output control data for authorizing a remote source (such as a vehicle center stack or stereo head unit) to assume control over stereo-associated features and functions of the portable audio player 230), such as for enabling a remote source to control various features on the audio player (such as, for example, play, stop, skip track, volume, pause, and the like.)

In one example in FIG. 2, the adapter 200 from transceiver module 220 is inserted into fitting 236, and the portable audio player 230 is powered on. A user can depress the control buttons 234 to control the audio output signal from the player 230 (such as stereo music). The output signal is transferred to Bluetooth transceiver 224 via cord 212 and conductor set 225, where, using the conventional Bluetooth format, it is up-converted and modulated onto the Bluetooth frequency band, and sent via conductor 226 and antenna 222 over the air.

On the receiving end, the portable device 102 in FIG. 1 contains a similar Bluetooth transceiver (as will be seen) and receives the audio signal, down-converts, demodulates, and filters the signal as appropriate, and sends the baseband audio signal over cord 112 to jack 100. Where, as will be described, jack 100 is inserted into a compatible auxiliary input of a stereo head unit, and the user activates the auxiliary input by selecting the appropriate button on the head unit, the audio signal is transferred to the car stereo and reproduced over the stereo's speakers.

In another embodiment, the user selects an appropriate control button 234 on portable audio player 230, and as a result, a control signal is output onto a designated pin (or set of pins) at fitting 236. When adapter 200 is connected to fitting 236, the control signal is sent as described above to the transceiver module 220, where it is sent over the air and received by the portable device 102. The control signal is then fed, via cord 112, into the auxiliary input. The control signal contains data requesting that the stereo head unit (or another piece of hardware in communication with the head unit) “take control” over the portable audio player 230 so that the user can subsequently use controls located on the stereo head unit, dashboard, or steering wheel, to control the playback of music over the speakers, including performing functions like pause, stop, volume control, etc.

In another embodiment, a user may depress one of the buttons on the portable device 102, such as multi-function button 109, in order to initiate the above sequence. In this instance, and assuming that the jacks and adapters are plugged in as described above, the user would depress button 109. Depressing button 109 would cause the portable plug device 102 to transmit a control signal to transceiver module 220 via antenna 222, which would be received by Bluetooth transceiver 224, and then transmitted via conductors 225 and cord 212 to the portable stereo player 230. That signal would, in turn, cause a sequence to be initiated which would result in the portable audio player 230 to initiate an acknowledging control signal back to auxiliary input of the stereo head unit, authorizing the stereo head unit (or its associated controls) to exercise control over the portable audio player 230. The user can then play audio or music from the portable audio player 230 in a “hands-free” fashion, by using the controls on the dashboard or head unit.

In another embodiment, the user may, after powering on and hooking up portable audio player 230 to the transmitter, depress button 109 on portable plug device 102 which may send a control signal directly to the auxiliary input of the stereo head unit, through cord 112 and jack 100. At that point, the stereo head unit is directed by data in that control signal to take control over the functions of the portable audio player 230, and the user may proceed to play audio over the car speakers and control the volume, track, etc., by use of controls disposed on the dashboard or head unit, which controls initiate control signals to be sent back to the portable audio device 230.

In yet another configuration, where such capabilities are integrated into the stereo head unit or related audio equipment, the occupant of the vehicle may simply touch a button on the dashboard or related area, which will cause this initiation sequence for “hands free” use of stereo-associated functions to commence.

In some embodiments, cord 112 will have an alternative adapter to that of jack 100 as discussed above, and in some configurations, the cord will be designed for insertion into an input at another location, such as the center stack of the vehicle or the dashboard, the head bezel, or an input to a multimedia bus. In these latter instances, the same basic operations can be performed.

FIG. 3 is a representation of the portable plug device 302 with buttons 306 and 308, multi-purpose button 309, standard charger adapter 310, and cord 312. In this embodiment, the portable plug device 302 may transmit and receive signals from a mobile telephone 340 via path 342 and antenna 322. It is assumed here for the purposes of this example that the mobile telephone is Bluetooth-enabled; that is, it has built within it a Bluetooth transceiver for transmitting and receiving the voice and data signals from the telephone 340 in a Bluetooth format. As will be described, the apparatus of the present invention enables a user to plug in the Bluetooth-compatible portable plug device and talk wirelessly by listening to voice transmission's over the car's speaker, and by speaking while in the vehicle. The occupant's audio speech is picked up by microphone 341 and transmitted back to the cellular telephone over the Bluetooth connection.

While the prior embodiments are discussed in the context of transceivers implementing the current Bluetooth standard, it should again be appreciated that any short-range wireless communication protocol capable of transmitting audio signals with high integrity (e.g., high dynamic range and high signal-to-noise ratio) can be substituted.

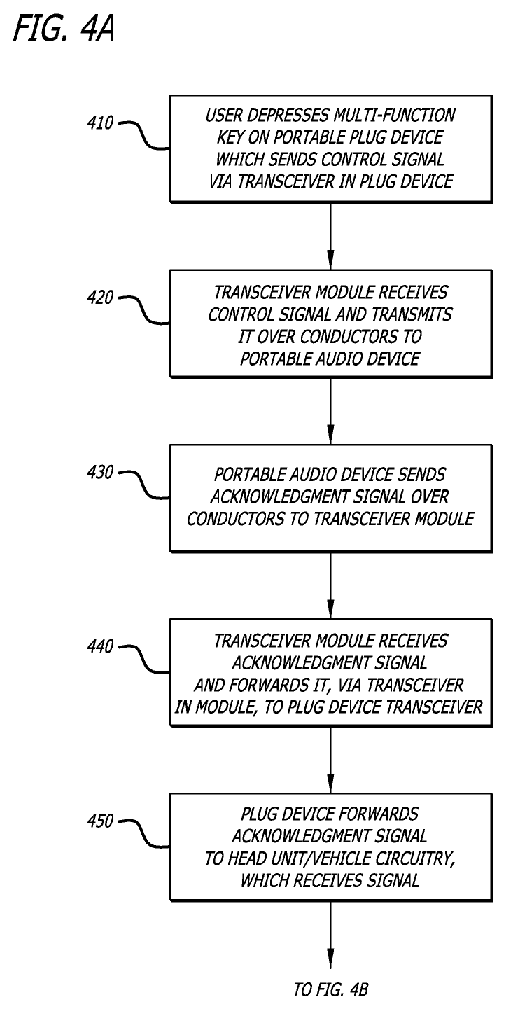

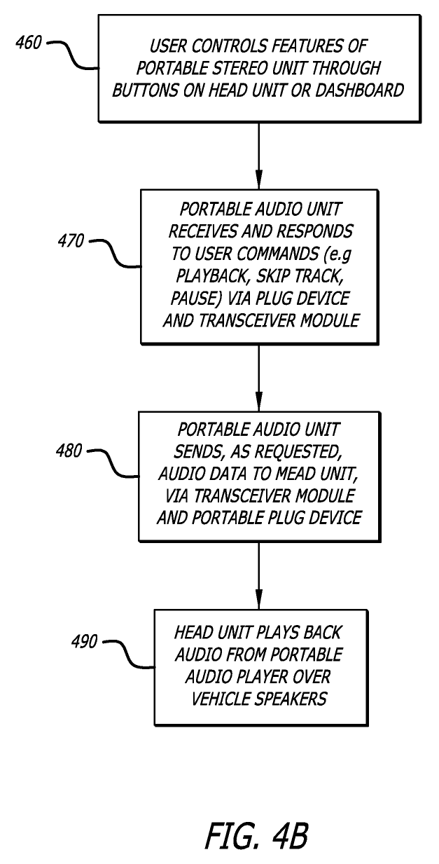

FIGS. 4A and 4B show a flowchart illustrating an exemplary embodiment of the invention. It is assumed for the purposes of these figures that the portable plug device of FIG. 1 is plugged into the auxiliary input of a stereo head unit, or alternatively, contains an adapter and/or wiring harness to connect cord 112 to an appropriate location, such as a jack on the rear of the head unit or a dedicated connection on the center stack, for transferring audio signals, and that the portable plug device is inserted into the cigarette lighter for power. It is further assumed that, in FIG. 2, the portable audio device is connected to the transceiver module via adapter 200 and fitting 236, and that the portable audio device and transceiver module are located within or proximate to the vehicle so that short range wireless standards such as IEEE 802.11, Bluetooth, etc., can properly function. It is also assumed that both the transceiver module and portable audio device are powered on.

Beginning with step 410 of FIG. 4A, a user depresses a multi-function key resident on the portable plug device in order to send a control signal over the air, using the transceiver in the plug device (for the purposes of this example, we assume that the transceiver uses an 802.11 wireless protocol). Next, the transceiver module receives the over-the-air signal, converts it to a format suitable for transmission over the conductors, and transmits the signal via the cord 212 in FIG. 2 to the portable audio device (step 420).

In step 430, the portable audio device receives the control signal over a dedicated wire in its multi-pin fitting, and recognizes the control signal as a request to allow an external device (in this case, the vehicle stereo) to assume various stereo-associated controls over the portable audio device. In response, the portable audio device transmits an “acknowledgement control” signal on a dedicated output pin at fitting 236, which is transmitted over the conductors found in cord 212 (FIG. 2) back to the transceiver module of the portable transceiver device 220. This “acknowledgement control” signal is intended to provide an indication to the external device (i.e., the car stereo) that the portable audio source has put itself in a mode to enable the audio-related hardware (e.g., the head unit) to assume various stereo-associated controls over the portable audio player (such as playback, stop, skip track, volume adjustment, and the like). In some configurations, the portable audio devices places itself in a “slave” mode for use by the master device (the head unit) and temporarily disables certain of the buttons 234 (FIG. 2).

The transceiver module receives this acknowledgement signal, converts the signal into a format conducive to wireless transmission, and transmits the signal using the 802.11 format over the air (step 440). The portable plug device, via its own 802.11 transceiver, receives the signal. At that point, the circuitry in the portable plug device demodulates the transmitted signal and forwards it to the head unit via cord 112 (FIG. 1) using the auxiliary input. (As noted, in other instances, the cord may alternatively be configured with an adapter and/or wiring harness in order to connect to another appropriate point in the vehicle that is designed for transmitting or receiving such signals.) The head unit receives the acknowledgment signal and forwards it to the appropriate circuitry to enable “master” mode whereby control of stereo-associated functions can be commenced and “hands-free mode” is thereby initiated (step 450).

As previously noted, the acknowledgement signal from the portable audio unit may not be necessary; in this case, the user simply depresses the multi-function button on the portable audio device, and this action sends a control signal over cord 112 (FIG. 1) directly to the head unit through the auxiliary input, allowing the vehicle's stereo to assume control of various features on the portable audio device. In another configuration, the occupant of the vehicle may simply depress or a button with similar functionality integrated into the vehicle, through the head unit or otherwise.

Referring now to FIG. 4B (step 460), in auxiliary mode, the user can now use controls on the head unit (or in some embodiments, other portions of the dashboard or the steering wheel) instead of the portable audio device to control features of the device simply by pressing standard buttons on the head unit such as stop, pause, skip or replay track, or adjust the volume using the volume knob. “Hands-free mode” is thus available to the user.

In step 470, the portable audio unit receives the user's commands as the user presses these buttons on the vehicle's head unit, and responds accordingly just as if the buttons 234 (FIG. 2) were directly pressed to control stereo-associated functions on the portable audio source 230. The signals flow in bidirectional fashion to and from the respective transceivers in the portable plug device and transceiver module. Next, in step 480, in response to a playback request input by the user on the head unit or dashboard, the portable audio unit transmits audio data to the head unit. In particular, the portable audio device uses one or more dedicated pins at fitting 236 to transmit audio data via connected adapter 200 (FIG. 2) and through cord 212 to the transceiver associated with the transceiver module, which up-converts and modulates the signal for transmission over-the-air, and transmits the streaming audio content. Thereupon, the transceiver associated with the portable plug device receives the wireless signal, down-converts and demodulates it, and transmits it through cord 112 (FIG. 1) and through jack 100 into the auxiliary input or of the stereo head unit. The stereo head unit then processes the audio data and causes reproduction of the audio associated with that data over the vehicle speakers (step 490).

Note that, in some embodiments, the transceiver module 220 (FIG. 2) need only contain a transmitter, such as when the portable audio device does not require any control signals or other inputs.

FIG. 5 shows a configuration of a wireless audio system in accordance with an embodiment of the present invention. Block 550 represents the interior of a vehicle within which the portable plug device 500 is used. Note that the conceptual illustration 500 of the portable plug device in FIG. 5 corresponds to the portable plug device 102 illustrated in FIG. 1, and that of 302 in FIG. 3.

In the embodiment shown in FIG. 5, the vehicle contains an exemplary stereo head unit 520 installed in the dashboard or console of the vehicle's interior 550. The head unit 520 contains a power/volume control knob 528, a control display 526, a CD/AUX button 521 with a corresponding input jack 530, an FM selector button 522, an AM selector button 524, and a cassette selector button 525. The head unit 520 further contains control knobs 527 for performing skips and seeks through music selections, as well as a CD input bay 531 and cassette bay 533.

Portable device 500 is configured to fit into a standard cigarette lighter using lighter plug 538 for supplying 12V of power to the portable device 500. Contained within the portable device 500 is a transceiver containing a receiver 530, a transmitter 532, a built-in microphone 555 which is connected to an input of transmitter 532, central processing unit 552 and memory 554. For the purposes of the illustration and the claims that follow, the transceiver shown contains all necessary digital and analog circuitry to function as a standard wireless transceiver. From the output of the receiver 530, a conductor 557 is fed into the input associated with radio 520, such as by using a standard 3.5 millimeter input jack. A control button 549 is coupled, directly or through intervening circuitry, to CPU 552.

Further included in the vehicle interior 550 is a cellular telephone 544 and a portable audio player 542. In this configuration, portable audio player 542 is attached to wireless transmitter 540 via a connection 543 from the output headphone jack of the portable audio unit to a standard 3.5 mm input jack on transmitter 540. In the embodiment shown in FIG. 5, the Bluetooth protocol is used by transmitter 540 coupled to the portable audio player 542, and by transmitter 532 and receiver 530 resident in portable plug device 500. The Bluetooth protocol, used in this example, provides efficient, high signal-to-noise ratio wireless communication channels between the respective devices.

Further, in this example, cellular telephone 544 is a standard Bluetooth-enabled phone, meaning that it contains the necessary Bluetooth transceiver functionality and circuitry to transmit and receive audio signals to and from Bluetooth receiver 530 and Bluetooth transmitter 532 via radio waves 560 and 561, respectively, resident in portable plug device 500. In like manner, Bluetooth transmitter 540 is configured to transmit wireless streaming audio to Bluetooth receiver 530 via radio waves 562. It will be contemplated by those skilled in the art, however, that numerous other types of suitable wireless technologies may be employed, such as those referenced above.

Disclosed further in FIG. 5 is a base station 541 which is capable of transmitting longer range cellular communications to and from cellular telephone 544 in a manner that is well known in the art. Further, base station 541 may be configured to wirelessly transmit data, such as audio files, either to telephone 544 or, in some configurations, to portable audio player 542 for subsequent streaming to portable device 500.

CPU 552 and memory 554 may be used to control various functions in the portable plug device 500 such as, for example, enabling the transmission of signals through the portable plug device 500 and for executing necessary code found in memory 554. Further, Bluetooth receiver 530 contains the functionality necessary to demodulate the wireless signal received from, e.g., the portable audio player and to convert it into a suitable format for transmitting the audio content over wire 557 to auxiliary input 530. In like manner, Bluetooth transmitter 536 contains the necessary transducer and electrical functionality to convert the voice data input into microphone 555 by a vehicle occupant into a format suitable for transmission to the cellular telephone 544. Portable device 500 also may contain a built-in button 575 (similar to button 109 in FIG. 1) for handling functions such as answering incoming telephone calls.

Using the portable plug device 500 of the present disclosure, a user may configure his or her vehicle to handle both incoming and outgoing calls, as well as to stream audio from a portable audio player such as a suitably configured PDA or MP3 player, without regard to the fact that the functionality is not present in or integrated in vehicle 520. Thus, portable plug device 520, in one embodiment, presents a “do-it-yourself” solution for enabling existing automobiles to be equipped with this wireless functionality at a minimum of effort.

Where a standard 3.5 mm Auxiliary input plug is not provided, such as in other aftermarket devices that contain such plugs in the rear of the unit or that contain manufacturer specific inputs, or where an OEM head unit is employed which integrates a manufacturer specific auxiliary input into the rear of the head unit or into another location in the vehicle console or head bezel, the portable device of the present invention can be easily configured to accommodate these differences. More particularly, the present invention works in conjunction with either aftermarket radio or head unit devices, or with OEM head units without regard to the specific type of auxiliary input. In any of these cases, with regard to streaming audio and unlike previous approaches using standard FM/AM radio waves as discussed above, the user is able to achieve a high quality CD-like sound from a portable music player with a minimum of installation effort, or in some cases, virtually effortless installation.

Yet another advantage of the present disclosure relates to the ability of a user to provide a seamless “do-it-yourself” solution to implement both hands free cellular technology and portable audio streaming using two portable devices. As an illustration, a user in the vehicle may stream CD-quality music from his or her portable music player and reproduce the music over the stereo speakers using the portable device 500 in FIG. 5. Then, when a telephone call comes in, the portable device 500 may signal the radio to mute the vehicle speakers so that the telephone ringtone may be recognized by the user and the call may be answered. In this instance, the caller's voice can be reproduced over the vehicle speakers, and the user in the vehicle can talk to the caller in a hands-free manner using the microphone 555 built into the portable device 500.

In similar fashion, the portable device 500 may signal the radio to handle volume control of the call using the standard radio control 528. This signal may be initiated by a user depressing button 549 to answer an incoming telephone call. Portable device 500 may optionally contain additional buttons, such as a send or redial button, to enable the sender to initiate telephone calls using portable device 500, or a button to terminate the call when the user is finished. Thus, depending on the technology integrated within the vehicle and the circuitry and signaling protocols that reside on the Bluetooth (or other wireless technology) enabled mobile telephone, the mobile telephone may in some configurations use the conduit of the portable plug device 500 to transmit and receive control signals to enable control buttons integrated into the vehicle dashboard or steering wheel to control functions associated with the mobile telephone—for example, downloading a phone list to the vehicle from the mobile telephone using the functions integrated in the portable plug device. A user can then select the desired feature, such as a “call” button, and make a telephone call by simply depressing the desired telephone number on a screen.

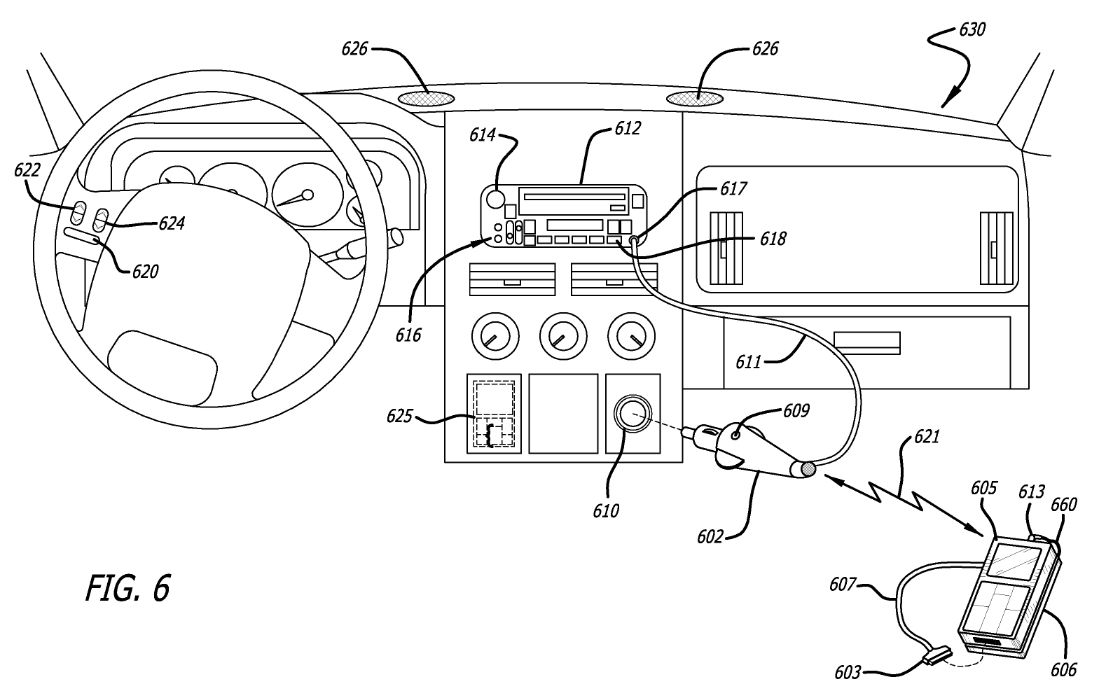

FIG. 6 shows an illustration of a vehicle dashboard 630, a portable media device 605, and transceiver module 606. The portable media device is piggybacked on the transceiver module 606. For the purpose of this illustration, the portable media device 605 is a portable music player such as an mp3 player or a PDA with mp3 capabilities. A multi-pin adapter is connected to the portable music player 605 using adapter 603 and cord 607. Cord 607 is attached to an appropriate input (not shown) on transceiver module 606. Alternatively, the portable audio device 605 may be connected to the to the headphone jack output 613 of the portable audio device 605 via cord 607.

Vehicle dashboard 630 further includes stereo head unit 612, power and volume control knob 614, stereo-associated settings 616, auxiliary button 618, and auxiliary input 617. Further enclosed is the portable plug device 602, which is shown connected to auxiliary input 617 via cord 611. Portable plug device 602 is configured to plug into cigarette lighter input 610. For purposes of this example, it is assumed that the portable plug device 602 has been properly inserted into cigarette lighter 610, thereby supplying power to portable plug device 602. Further, the rectangular box 625 shows an optional seating mechanism for easy insertion of the transceiver module 603 and portable music player 605 onto the dashboard or in between the driver and passenger.

In addition, on the steering wheel are shown additional stereo-associated functions “skip/replay” track button 622, volume control button 624, and “mode” button 620, for added convenience for the driver. After the portable music player is powered up and the user selects the auxiliary mode by depressing button 618, the user may touch multi-function button 609 to allow the stereo controls 614 and 616 of head unit 612, or alternatively, stereo controls 620, 622, and 624 to control the various playback features of the streamed audio in a manner described earlier in this specification. Advantageously, in this embodiment, the user may keep his or her eyes on the road, rather than looking to the controls of the portable music player 605 to adjust settings.

As noted above, in an alternative embodiment, the output headphone jack 613 of the portable music player 603 may be connected to an input of the transceiver module 606 via cord 660, in lieu of connecting the portable music player to the transmitter via the multi-pin connection 603. In this embodiment, audio may be streamed to the head unit for playback over the car speakers 626, but it may not be possible to allow the vehicle's stereo controls to control playback of the portable music player 605. In this simplified configuration, however the audio signal is streamed to the transceiver module 606 via cord 607 emanating from the headphone jack 613. In addition, transceiver module 606 in this implementation need not contain full transceiver circuitry, but may, for example, just contain wireless transmitter circuitry sufficient to transmit the signal wirelessly to the portable plug device 602. In like manner, the portable plug device 602 in this embodiment need only contain a wireless receiver rather than full transceiver functionality, in which case the portable plug device 602 would receive the wireless signal as depicted by jagged line 621, demodulate it, and transmit the resulting audio signal to the auxiliary input 617 of the stereo head unit 612 for playback over the vehicle speakers.

In alternative embodiments, and depending on the signaling protocols employed by both the portable media device and circuitry integrated into the head unit or other location in the vehicle, a multi-pin connector will not be necessary to establish control by the vehicle's stereo controls over the portable media device. For example, a single input/output conductor or conductor set may be contemplated by those in the art that uses, for example, a handshaking format to establish which device(s) will be the master and which will be the slave for purposes of controlling the portable media device, and thereafter, media can be subsequently transmitted in the manner contemplated by the invention. These handshaking techniques and the relative sophistication of the vehicle's circuitry and compatible media player represent design details that may be implemented as alternatives, that do not depart from the scope or spirit of the present invention.

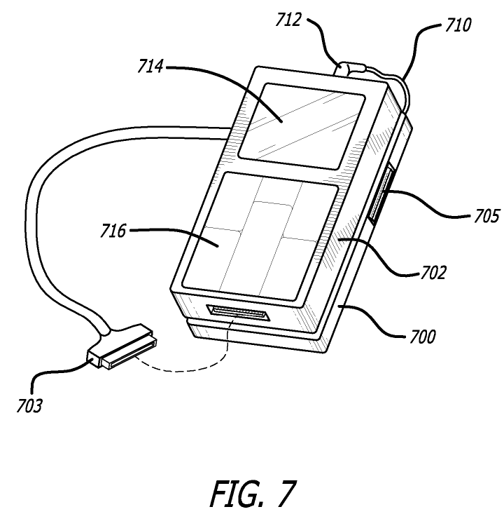

FIG. 7 is an enlarged view of the transceiver module 700, wherein portable media player 702 is piggybacked onto the transceiver module 700. Additionally, multi-pin connector 703 is illustrated, as is headphone jack 712 which, in this embodiment, is connected to an input (not shown) of transceiver module 700. Multi-pin fitting 705 is, in some configurations, likewise resident on the transceiver, and may be used to connect to the multi-pin connector 703 as earlier described with reference to FIG. 2. As before, portable media player 702 contains window 714, and user control buttons 716. It should be noted that the piggybacked configuration is for illustrative purposes only, and is not necessary for an understanding of the invention. Portable transceiver module 700, in one embodiment, contains the functionality as described earlier with respect to FIGS. 2 and 5, regardless of its physical shape.

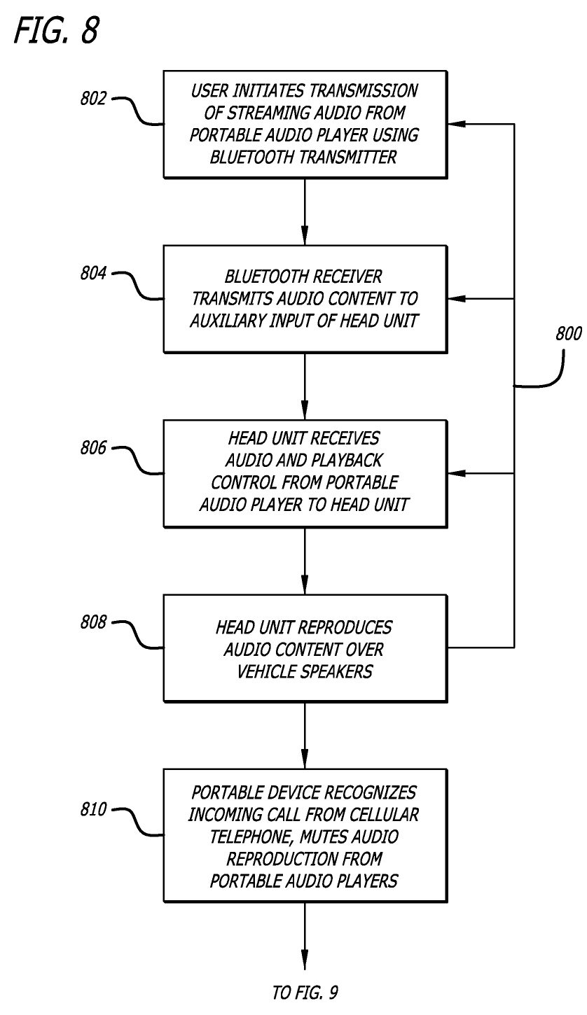

FIG. 8 shows a conceptual diagram of the steps a user may take in using an embodiment of the present invention. As discussed above, the user may install the portable plug device by inserting it into the vehicle's cigarette lighter and using the cord 112 (FIG. 1) to attach the portable plug device to the auxiliary input of the vehicle's head unit. For purposes of this illustration, it is also assumed that the user has a portable audio player (such as an MP3 player) which he or she has connected to the external transceiver module as illustrated by FIGS. 2, 6, and 7. For purposes of this illustration, it is assumed that the Bluetooth protocol is used and implemented in the portable plug device and the portable transceiver module. In addition, it is assumed that the user has in the vehicle a Bluetooth-enabled mobile telephone, such as that shown by reference 340 in FIG. 3. It should be understood, again, that other high-quality short range wireless protocols as described above may be equally suitable, without departing from the spirit and scope of the present invention.

Referring back to FIG. 8, the user may initiate transmission of stereo music or other audio from an MP3 player (or audio-enabled PDA, laptop computer, etc.) by powering the MP3 player on and depressing a play switch (such as the multi-feature button shown in reference number 309 of FIG. 3) to play back one or more songs in, for example, a playlist of songs resident on the memory of the portable audio player. The music comes out of the headphone jack or multi-pin connector of the portable audio player and is fed into the portable transceiver module. At that point, the portable transceiver module converts the audio content into a known format suitable for transmission over the wireless medium using the standard Bluetooth protocol (step 802). Thereupon, the Bluetooth transceiver resident in the portable plug device (which has previously been paired with the portable transmitter to establish a wireless connection) receives the wireless communication, reconverts the signal using known circuitry resident in or proximate to the Bluetooth receiver within the portable plug device, as well as the CPU and associated memory, and transmits the stereo music over the auxiliary cord into the auxiliary input of the head unit (step 804). Alternatively, the stereo head unit or other circuitry in the vehicle may assume control over the functions of the portable media player, as previously described, thereby enabling the user to control the stereo via controls on the dashboard and head unit. The head unit, which has been placed in auxiliary mode by the user, receives the stereo music, and may also in some embodiments receive additional control signals from the portable plug device enabling the transfer of control of stereo-associated settings like volume and other settings from the MP3 player to be controlled by the head unit (step 806). In these other embodiments, the user will be able to control and adjust settings on the head unit (e.g., volume, stop, pause, skip, play, etc.) without further intervention from the portable plug device, as control signals are transmitted to the portable media device through its multi-pin connector. The head unit thereafter reproduces the audio content over the vehicle speakers in a standard fashion, under control of the user (step 808).

At step 810 in FIG. 8, the mobile telephone rings. The Bluetooth receiver (and transmitter) resident in the portable plug device has been similarly paired with the Bluetooth transceiver integrated into the mobile telephone, and is configured at that point to electronically terminate receiving audio signals addressed to the transceiver from the portable Bluetooth transceiver connected to the MP3 player or other audio device. In other embodiments, the mobile telephone does not have an integrated Bluetooth transceiver, but rather is coupled to an external transceiver that performs substantially the same functions as the integrated receiver in a Bluetooth-enabled mobile telephone.

At that point, the portable plug device is further configured to terminate the transmission of audio content to the head unit, thereby effectively muting the reproduction of music over the speakers in order to accommodate the user's receipt of the incoming call (step 810). Note that steps 802, 804, 806, and 808 collectively constitute a first interval of time whereby the user is listening to audio streamed from the portable audio player. Step 810 represents a transition period whereby, as noted, the initiation of transmissions from the mobile telephone cause the streaming audio to the head unit to terminate, and in effect mute the speakers. (Note that, in other configurations, the CPU may transmit a signal over a control channel to the head unit to terminate the audio playback on the speakers).

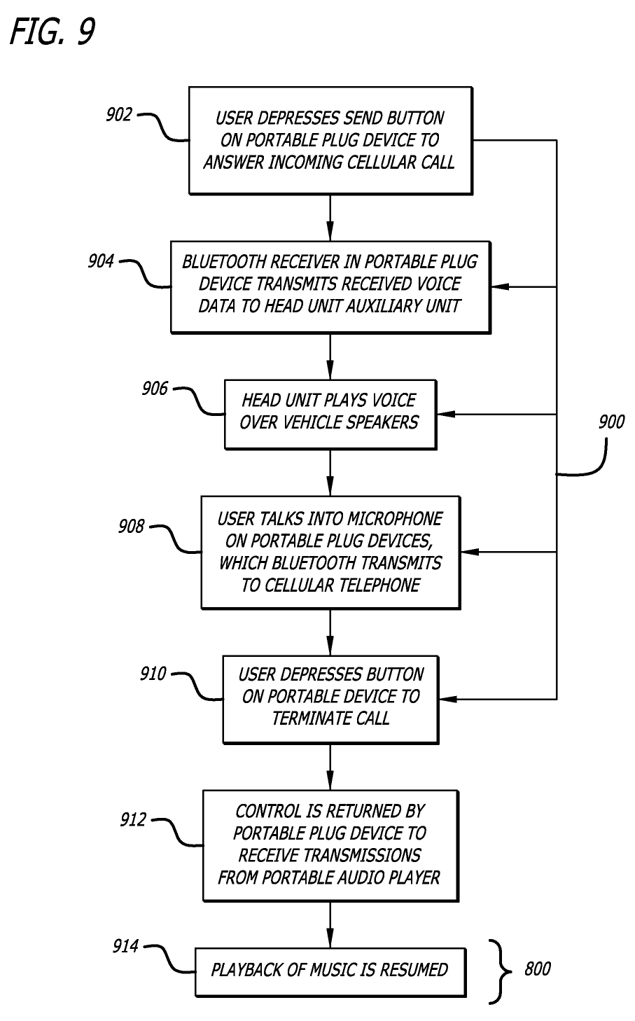

Control is then passed to FIG. 9. The user depresses a send button located on the portable plug device to answer the incoming call (step 902), such as the multi-feature button 109 resident on portable plug device 102 in FIG. 1. At this point, the Bluetooth transceiver resident in the portable plug device may receive voice communications from the Bluetooth transceiver in the mobile telephone. Those voice communications are converted by the Bluetooth transceiver in the portable plug device into audio content suitable for transmission over the cord emanating from the portable plug device to the auxiliary input of the head unit (step 904). The head unit then reproduces the caller's voice over the speakers in the vehicle (step 906). At the same time, the user may talk to the caller by simply speaking in a normal manner, and the speech is picked up by the microphone resident on the portable plug device (reference 104 at FIG. 1). The voice received by the microphone is transferred to the Bluetooth transmitter resident in the portable plug device, through known transducer and electrical circuitry, to modulate and convert the voice data into audio content suitable for transmission over the wireless Bluetooth medium (step 908). When the user has completed the call, he or she may optionally depress a button on the portable plug device, such as the multi-function button, to terminate the conversation (step 910). At that instant, communications between the mobile telephone's Bluetooth transceiver and the portable plug device are terminated, and control may be returned by the Bluetooth receiver in the portable plug device to resume the reception and transmission of music content over the wireless medium to the head unit from the audio player (step 912). Playback of stereo music is then resumed over the vehicle's speakers, under the control of the head unit (step 914).

In some embodiments, the head unit or associated circuitry resident on the vehicle may have the capability of pausing the reproduction of music over the speakers pending the resolution of a telephone call. Further, initiation (as opposed to receipt) of telephone calls by a caller in the vehicle who is currently listening to audio streamed from the portable audio device may work in a substantially similar manner, using the reverse steps as those illustrated in FIGS. 8 and 9.

It should be noted that the pairing of Bluetooth devices and the ability of one Bluetooth device to supersede communications over another are techniques known in the art, and that similar short-range wireless communication techniques contain similar protocols for arbitrating between a plurality of wireless devices.

Steps 902, 904, 906, 908, and 910 represent a second time interval whereby control of the portable plug device is allocated to the mobile telephone. Step 912 represents an intermediate step whereby control is returned to the portable audio player and reproduction of audio from the player is re-initiated. Step 914 represents the resumption of time interval 800 (FIG. 8) wherein the reproduction of audio from the portable audio player is resumed.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus for reproducing audio in a vehicle comprising:
a portable device configured to fit into a cigarette lighter comprising a wireless receiver and one or more conductors coupled to an output of the wireless receiver, a portion of the one or more conductors extending as a cord from the portable device, the cord configured to connect to an auxiliary input on a stereo head unit, the portable device further comprising at least one button disposed substantially on its perimeter for controlling the receipt of audio content;
wherein the wireless receiver is configured to receive audio content using a Bluetooth protocol from a portable wireless transmitter coupled to a portable audio device;
wherein the audio content is transmitted to the auxiliary input over the one or more conductors; and
wherein the stereo head unit reproduces the audio content over speakers in the vehicle.

2. The apparatus of claim 1 wherein the cord comprises a 3.5 millimeter input jack which is configured to fit into the auxiliary input of the head unit.

3. The apparatus of claim 1 wherein the auxiliary input jack is located on the front face of the head unit.

4. A portable device for sending and receiving wireless communications in a vehicle and configured to fit into a cigarette lighter, the portable device comprising:
a first wireless transceiver for sending and receiving data, and a cord extending from the portable device and configured to connect the first wireless transceiver to one or more conductors in the vehicle which are dedicated to controlling audio functions; and
a microphone disposed on the portable device and coupled to an input of the first wireless transceiver; wherein:
the portable device is configured to transmit and receive control signals from one of a second wireless transceiver and a mobile telephone, the second wireless transceiver coupled to a portable audio source for enabling communications with the first wireless transceiver; and wherein at least one button disposed on a perimeter of the portable device is configured to control transmission of audio content for reproducing the audio content on speakers in the vehicle.

5. The apparatus of claim 4 wherein the portable device is configured to transmit, and the portable audio source is configured to receive, control signals for enabling an occupant in the vehicle to control settings associated with the reproduction of audio content by using audio controls integrated in the vehicle.

6. The apparatus of claim 4 wherein the button is used to answer calls from the mobile telephone.

7. The apparatus of claim 4 wherein the portable device is configured to mute the speakers when an incoming telephone call arrives.

8. The apparatus of claim 4 wherein the portable audio source comprises an audio player capable of reproducing audio content in an MP3 format.

9. The apparatus of claim 4 wherein the portable audio source comprises a personal digital assistant (PDA).

10. The apparatus of claim 4 wherein the portable audio source comprises a laptop computer.

11. The apparatus of claim 4 wherein the first and second wireless transceivers use a Bluetooth transmission protocol.

12. The apparatus of claim 4 wherein the first and second wireless transceivers use one of the wireless protocols governed by I.E.E.E. 802.11.

13. An apparatus for reproducing audio in a vehicle comprising:
a portable device configured to fit into a vehicle cigarette lighter comprising a wireless receiver, a first wireless transmitter, a microphone, at least one button disposed on its perimeter, a controller coupled to the wireless receiver, and a cord extending from the portable device and configured to fit into an auxiliary input jack of a stereo head unit;
wherein the wireless receiver is configured to receive audio content during a first interval from a second wireless transmitter coupled to a portable audio player and from a cellular telephone during a second interval;
wherein the wireless transmitter is coupled to the microphone and configured to transmit audio content to the cellular telephone during the second interval; and
wherein the controller is configured to allocate a wireless communication channel only to the portable audio player during the first interval and only to the cellular telephone during the second interval for enabling reproduction of audio content over speakers in the vehicle, and for enabling transmissions of audio content from the wireless transmitter to the cellular telephone during the second interval.

14. The apparatus of claim 13 wherein the wireless receiver, first wireless transmitter, and second wireless transmitter use a Bluetooth protocol.

15. The apparatus of claim 13 wherein the wireless receiver, first wireless transmitter, and second wireless transmitter use an I.E.E.E. 802.11 protocol.

16. The apparatus of claim 13 wherein the portable device further comprises a SEND button for initiating outgoing telephone calls.

17. The apparatus of claim 13 wherein the portable device further comprises an END button for terminating incoming telephone calls.

18. The apparatus of claim 13 wherein the cord is configured to fit into a 3.5 millimeter input jack of a head unit.

19. The apparatus of claim 13 wherein the auxiliary input jack is located on the front face of the stereo head unit.

20. A portable device configured to fit into a cigarette lighter socket of a vehicle, comprising:
a receiver using a Bluetooth protocol;
memory and a central processing unit for controlling the receiver;
a cord extending from the portable device with an output jack at its terminating point configured to connect to an input jack in the vehicle associated with control of a stereo head unit and to transmit signals from the receiver to the head unit; and
at least one button disposed on its perimeter; wherein
the portable device is configured to receive wireless signals from a transmitter module for transmitting audio content from an audio source coupled to the transmitter module to the receiver in the portable device; and wherein the portable device is configured to transfer the audio content via the cord to the head unit for playback of the audio content over the speakers.

21. The portable device of claim 20 further comprising a transmitter using the Bluetooth protocol, and a microphone coupled to the transmitter, for enabling the portable device to effect communications between a user of a Bluetooth-enabled mobile telephone.

22. The portable device of claim 20 wherein the button is configured to answer incoming calls.

23. The portable device of claim 20 further configured to mute the speakers when an incoming call arrives.

24. The portable device of claim 20 wherein the transmitter module further comprises a wireless receiver, and wherein the audio source comprises a multi-pin connector configured to connect with the transmitter module.
